(19) United States
(12) Patent Application Publication
(10) Pub. No.: US 2016/0026399 A1
(43) Pub. Date: Jan. 28, 2016

(54) BLOCK I/O INTERFACE FOR A HOST BUS ADAPTER THAT UTILIZES NVDRAM

(71) Applicant: LSI Corporation, San Jose, CA (US)

(72) Inventors: Saugata Das Purkayastha, Bangalore (IN); Anant Baderdinni, Norcross, GA (US); Philip K. Wong, Austin, TX (US); Vineet Agarwal, Banglore (IN)

(21) Appl. No.: 14/338,645

(22) Filed: Jul. 23, 2014

(51) Int. Cl. G06F 3/06

(52) U.S. Cl. CPC G06F 3/0619; G06F 3/0688; G06F 3/0685; G06F 3/0655; G06F 3/065

(57) ABSTRACT

A block I/O interface for a HBA is disclosed that dynamically loads regions of a SSD of the HBA to a DRAM of the HBA. One embodiment is an apparatus that includes a host system and a HBA. The HBA includes a SSD and DRAM. The host identifies a block I/O read request for the SSD, identifies a region of the SSD that corresponds to the read request, and determines if the region is cached in the DRAM. If the region is cached in the DRAM, then the HBA copies data for the read request to the host memory and a response to the read request utilizes the host memory. If the region is not cached, then the HBA caches the region of the SSD in the DRAM, copies the data for the read request to the host memory, and a response to the read request utilizes the host memory.

### FIELD OF THE INVENTION

The invention generally relates to field of storage controllers.

### BACKGROUND

Non-Volatile Dynamic Random Access Memory (NVDRAM) is a combination of volatile memory (e.g., Dynamic Random Access Memory (DRAM)) and non-volatile memory (e.g., FLASH), manufactured on a single device. The non-volatile memory acts as a shadow memory such that data stored in the volatile memory is also stored in the non-volatile memory. When power is removed from the device, the data stored in the non-volatile portion of the NVDRAM remains even though the data stored in the DRAM is lost. When NVDRAM is used in a Host Bus Adapter (HBA), the volatile portion of the NVDRAM is mapped to the address space of the host system and the host system can directly access this volatile memory without going through a storage protocol stack. This provides a low latency interface to the HBA. However, the capacity of the DRAM is often many times smaller than the capacity of the SSD, due to power consumption limitations, the usable memory-mapped address space of the HBA to the host system, the available die area of the NVDRAM device, etc. Thus problems arise in how to efficiently allow a host system of the HBA to have a low latency access to the larger SSD, while bypassing the storage protocol stack in the host system.

### SUMMARY

Processing of block Input/Output (I/O) requests for a HBA that includes NVDRAM is performed, in part, by dynamically loading parts of a larger sized SSD of the HBA into a smaller sized DRAM of the HBA. The DRAM operates as a low latency, high speed cache for the SSD and is mapped to host system address space. One embodiment is an apparatus that includes a host system and a HBA. The host system includes a host processor and a host memory. The HBA includes a SSD and DRAM. The DRAM is operable to cache regions of the SSD. The host processor is operable to identify a block I/O read request for the SSD, to identify a region of the SSD that corresponds to the block I/O read request, and to determine if the region of the SSD is cached in the DRAM of the HBA. The host processor, responsive to determining that the region of the SSD is cached in the DRAM of the HBA, is further operable to direct the HBA to perform a memory copy of a block of data for the block I/O read request from the cached region of the SSD to the host memory, and to respond to the block I/O read request for the SSD utilizing the block of data in the host memory. The host processor, responsive to determining that the region of the SSD is not cached by the DRAM of the HBA, is further operable to direct the HBA to cache the region of the SSD in the DRAM of the HBA, to direct the HBA to perform a memory copy of the block of data for the block I/O read request from the cached region of the SSD to the host memory, and to respond to the block I/O read request for the SSD utilizing the block of data in the host memory.

The various embodiments disclosed herein may be implemented in a variety of ways as a matter of design choice. For example, some embodiments herein are implemented in hardware whereas other embodiments may include processes that are operable to construct and/or operate the hardware. Other exemplary embodiments are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of a host system employing a HBA for storage operations in an exemplary embodiment.

FIG. 2 is flow chart of a method for processing block I/O read requests for a SSD in an exemplary embodiment.

FIG. 3 is a flow chart of a method for processing block I/O write requests for a SSD in an exemplary embodiment.

FIG. 4 is a block diagram of a host system and a HBA that utilizes a file system interface to access a SSD in an exemplary embodiment.

FIG. 5 is a block diagram of a host system and a HBA that utilizes a memory mapped interface to access a SSD in an exemplary embodiment.

FIG. 6 illustrates an exemplary computer system operable to execute programmed instructions to perform desired functions.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

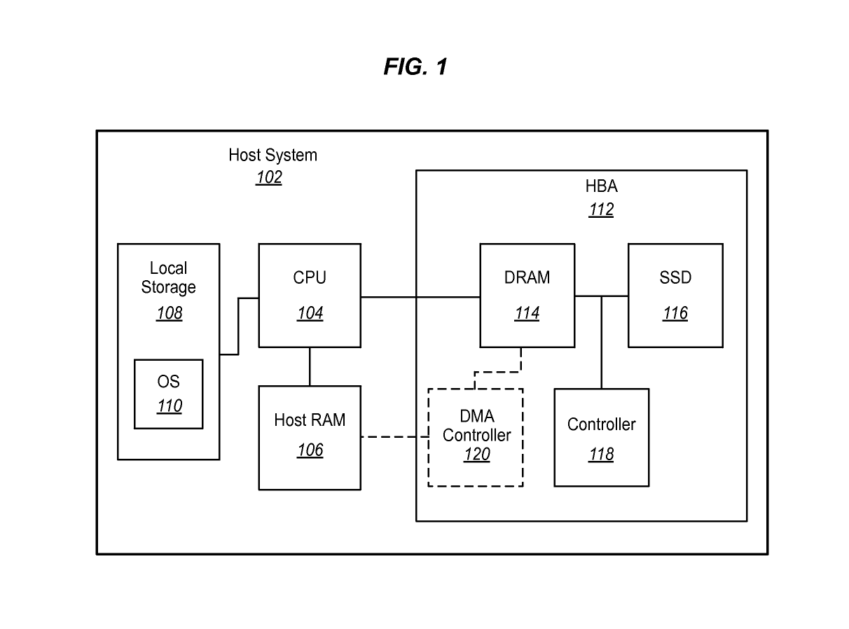

FIG. 1 is a block diagram of a host system 102 employing a HBA 112 for storage operations in an exemplary embodiment. Host system 102, as is typical with most processing systems, includes a central processing unit (CPU) 104, host random access memory (RAM) 106, and local storage 108 (e.g., a local disk drive, SSD, or the like) that stores an operating system (OS) 110. HBA 112 includes a DRAM 114 that is backed by an SSD 116. HBA 112 also includes a controller 118 that is operable to, among other things, direct storage operations on behalf of HBA 112. Thus, HBA 112 is any device, system, software, or combination thereof operable to perform storage operations on behalf of the host system 102. In some embodiments, HBA 112 includes a Direct Memory Access (DMA) controller 120, although host system 102 in some embodiments may also include DMA controller 120. With DMA controller 120 present in HBA 112 and/or host system 102, CPU 104 is able to set up a memory transfer utilizing DMA controller 120, which then transfers data between host RAM 106 and DRAM 114 without further intervention by CPU 104. DMA may be utilized for larger data transfers between host RAM 106 and DRAM 114, with CPU 104 utilized for smaller memory transfers between host RAM 106 and DRAM 114.

CPU 104 is communicatively coupled to HBA 112 and maps DRAM 114 into an address space of OS 110 to allow applications of OS 110 to directly access cached data of SSD 116. For example, OS 110 comprises applications that are used by the host system 102 to perform a variety of operations. Some of those applications may be used to access data stored in SSD 116, which might be cached within DRAM 114 of HBA 112. And, DRAM 114 is mapped into an address space of host system 102 and thus any cached data can be directly copied from DRAM 114 to an application buffer in host RAM 106.

Typically, there are limitations as to the size of DRAM 114 as compared to the size of SSD 116. For instance, the size of DRAM 114 may be limited by power considerations, by cost considerations, by architecture limitations of host system 102 that may not allow HBA 112 to map large address spaces into OS 110. However, applications can often utilize the large capacity storage that is available through the ever-increasing storage capacities of SSDs, such as SSD 116. Thus, problems exist as how to allow applications to access the large storage capacity of an SSD while maintaining the benefit of low latency access to HBA DRAM 114.

In this embodiment, HBA 112 is able to allow the applications to use the larger sized SSD 116 while caching SSD 116 within the smaller sized DRAM 114 by dynamically loading regions of SSD 116 into and out of DRAM 114 as needed. In some cases, it is not possible to map the entirety of SSD 116 into the address space of OS 110, due to limitations in host system 102. For instance, if HBA 112 utilizes a Peripheral Component Interconnect (PCI) or PCI express (PCIe) interface, then the usable address space of HBA 112 may be limited to 4 GigaBytes (GB). However, it is typical for the size of SSD 116 to be much larger than 4 GB.

In the embodiments described, SSD 116 is segmented into a plurality of regions, with each region being able to fit within DRAM 114. For instance, if DRAM 114 is 1 GB and SSD 116 is 100 GB, then SSD 116 may be segmented into a plurality of 4 MegaByte (MB) regions, with controller 118 able to copy regions of SSD 116 into and out of DRAM 114 as needed to respond to I/O requests generated by host system 102 (e.g., by I/O requests generated by applications executing within the environment of OS 110). In the embodiments described, the I/O requests are block I/O requests for SSD 116, which is registered as a block device for host system 102 and/or OS 110. The block I/O requests may bypass the typical protocol stack found in OS 110 to allow for a high speed, low latency interface to SSD 116. This improves the performance of HBA 112.

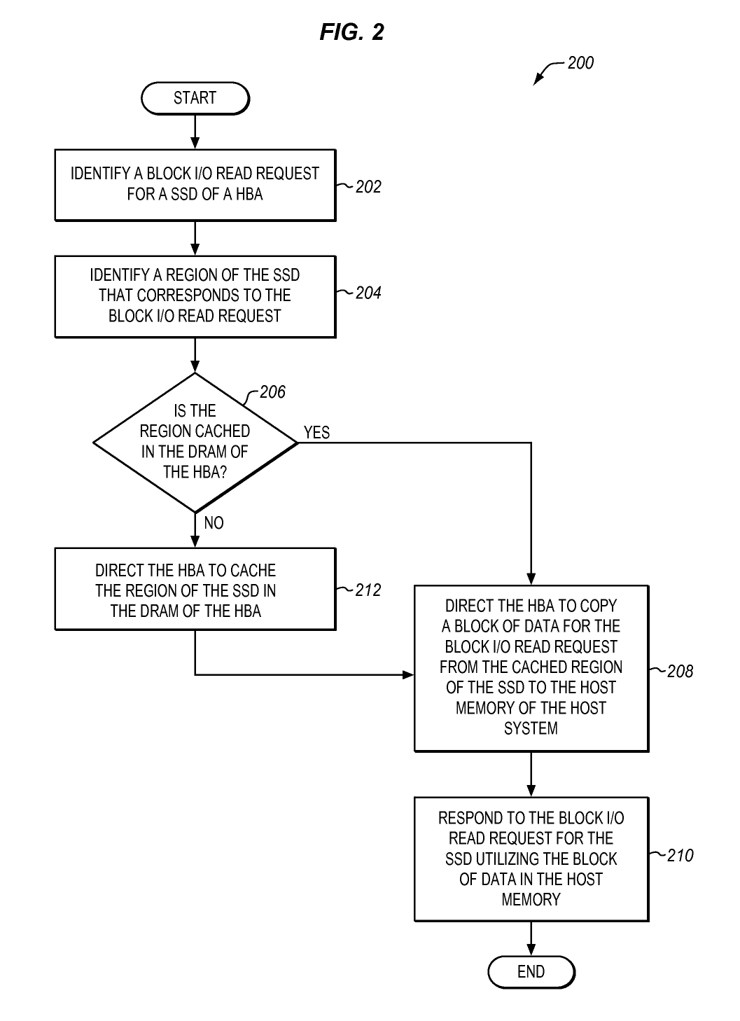

FIG. 2 is flow chart of a method 200 for processing block I/O read requests for SSD 116 in an exemplary embodiment. The steps of method 200 will be described with respect to FIG. 1, although one skilled in the art will recognize that method 200 may be performed by other systems not shown. In addition, the steps of the flow charts shown herein are not all inclusive and other steps, not shown, maybe included. Further, the steps may be performed in an alternate order.

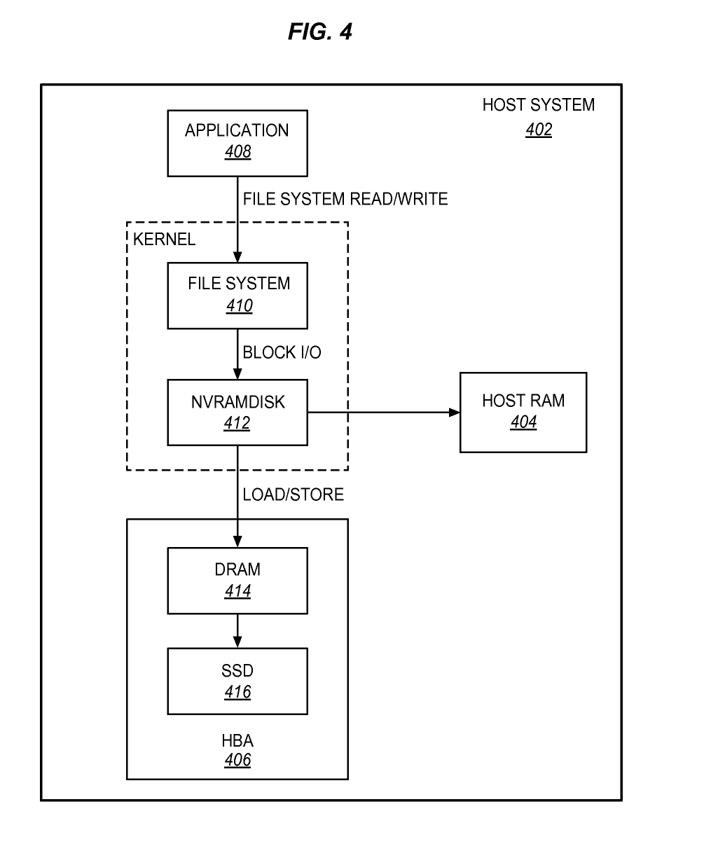

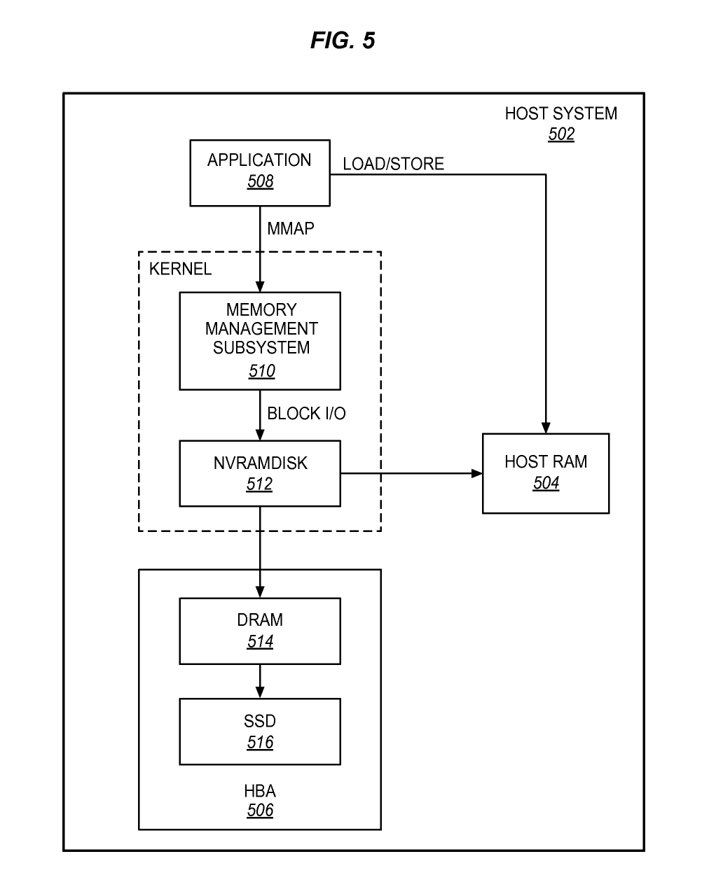

During operation of host system 102, OS 110 may register SSD 116 as a block device for I/O operations. As a block device, SSD 116 is read/write accessible by OS 110 in block-sized chucks. For instance, if the smallest unit of data that can be read from, or written to, SSD 116 is 4 KiloBytes (KB), then OS 110 may register SSD 116 as a 4 KB block device to allow applications and/or services executing within OS 110 to read data from, or write data to, SSD 116 in 4 KB sized chunks of data. A simple example of a block device driver for a registered block device may accept parameters that include a starting block number of the device to read from and the number of blocks to read from the device. As applications and/or services executing within OS 110 generate block I/O read requests for SSD 116 (e.g., the applications and/or services are requesting that data be read from SSD 116), CPU 104 of host system 102 monitors this activity and identifies the read requests (see step 202 of FIG. 2). To do so, CPU 104 may be executing a service or device I/O layer within OS 110 that is able to intercept and identify the block I/O read requests for SSD 116. This will be discussed later with respect to FIGS. 4-5.

In response to identifying the block I/O read request, CPU 104 identifies a region of SSD 116 that corresponds to the block I/O read request (see step 204 of FIG. 2). For instance, if the block I/O read request spans blocks 400-500 for SSD 116, then CPU 104 may analyze how SSD 116 is segmented into regions of blocks, and determine which region(s) blocks 400-500 are located within. If, for instance, SSD 116 is segmented into a plurality of 4 MB regions, then each region corresponds to about 1000 blocks (if each block is 4 KB). In this case, a block I/O read request for blocks 400-500 would be located in one of the first few regions of SSD 116 (e.g., region 0 or 1), if SSD 116 is segmented in a linear fashion from the lowest block numbers to the highest block numbers. This is merely one example however, and one skilled in the art will recognize that the particular manner or size of the regions, the block size, and the region ordering is a matter of design choice.

In response to identifying a region of SSD 116 that corresponds to the block I/O read request, CPU 104 determines if the region is cached in DRAM 114 (see step 206 of FIG. 2). To determine if the region is cached, CPU 104 may analyze metadata that identifies which regions of SSD 116 are cached within DRAM 114. Such metadata may be stored in DRAM 114 and/or SSD 116 as a matter of design choice. If the region that corresponds to the block I/O read request is cached in DRAM 114, then CPU 104 directs controller 118 of HBA 112 to perform a memory copy of a block of data for the block I/O read request from DRAM 114 to host RAM 106 (see step 208 of FIG. 2). Generally, the block of data for the block I/O read request corresponds to data block(s) that have been requested by the read request. For instance, if the block I/O read request is for blocks 400-500 of SSD 116, then controller 118 copies the cached blocks 400-500 from DRAM 114 to host RAM 106. In some embodiments, controller 118 may perform a memory copy from DRAM 114 to host RAM 106 and/or may initiate a DMA transfer from DRAM 114 to host RAM 106 in order to perform this activity. In other embodiments, CPU 104 may perform a memory copy from DRAM 114 to host RAM 106, and/or may initiate a DMA transfer from DRAM 114 to host RAM 106 to perform this activity. In response to performing a memory copy of the blocks of data for the block I/O read request to host RAM 106, CPU 104 responds to the block I/O read request for SSD 116 utilizing the data in host RAM 106 (see step 210 of FIG. 2).

One advantage of responding to the block I/O read request using data cached in DRAM 114 is reduced latency. Typically it is much faster to perform a memory copy or DMA transfer from DRAM 114 to host RAM 106 than it is to wait for SSD 116 to return the data requested by the block I/O read request. Although SSDs in general have lower latencies than rotational media such as Hard Disk Drives, SSDs are still considerably slower than DRAM. Thus, it is desirable to cache SSD 116 in DRAM 114, if possible. However, differences in the size between DRAM 114 and SSD 116 typically preclude the possibility of caching SSD 116 entirely in DRAM 114.

If the region that corresponds to the block I/O read request is not cached in DRAM 114, then CPU 104 directs controller 118 to cache the region of SSD 116 in DRAM 114 (see step 212 of FIG. 2). For instance, controller 118 may locate the region corresponding to the block I/O read request stored on SSD 116, and then copy the region from SSD 116 to DRAM 114. In some cases, DRAM 114 may not have the free space for the region if DRAM 114 is full of other cached regions of SSD 116. In this case, controller 118 may first flush a dirty region in DRAM 114 to SSD 116, if the region has been modified (e.g., via a block I/O write request for data in the region) prior to copying the region corresponding to the block I/O read request from SSD 116 to DRAM 114. If some of the cached regions in DRAM 114 are not dirty (e.g., the cached region in DRAM 114 includes the same data as is located on SSD 116), then controller 118 may simply mark the region in DRAM 114 as available and then copy over the now available region in DRAM 114 with data from SSD 116.

In response to caching the region from SSD 116 to DRAM 114, CPU 104 directs controller 118 to copy the block of data for the block I/O read request from the cached region(s) in DRAM 114 to host RAM 106 (see step 208 of FIG. 2, which has been previously discussed above). CPU 104 then responds to the block I/O read request for SSD 116 utilizing the block of data in host RAM 106 (see step 210 of FIG. 2, which has been previously discussed above).

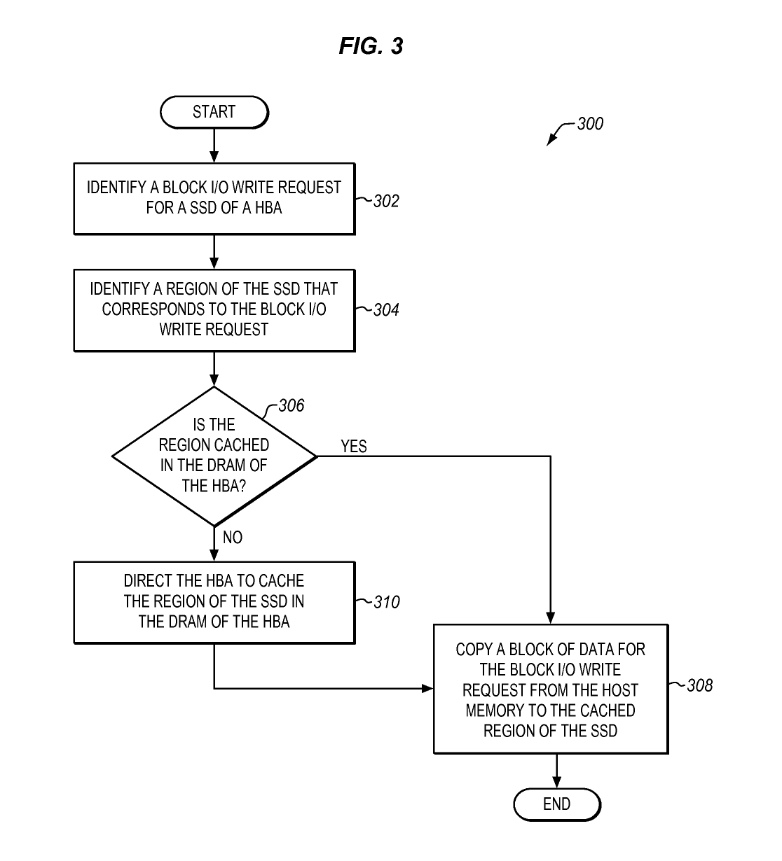

In some cases, applications and/or services executing within OS 110 may generate block I/O write requests for SSD 116 (e.g., the applications and/or services are attempting to modify data stored on SSD 116). FIG. 3 is flow chart of a method 300 for processing block I/O write requests for SSD 116 in an exemplary embodiment. The steps of method 300 will be described with respect to FIG. 1, although one skilled in the art will recognize that method 300 may be performed by other systems not shown.

During operation of host system 102, applications and/or services executing within OS 110 generate block I/O write requests for SSD 116. CPU 104 of host system 102 monitors this activity and identifies the write requests (see step 302 of FIG. 3). To do so, CPU 104 may be executing a service or device I/O layer within OS 110 that is able to intercept and identify the block I/O write requests for SSD 116. This will be discussed later with respect to FIGS. 4-5.

In response to identifying the block I/O write request, CPU 104 identifies a region of SSD 116 that corresponds to the block I/O write request (see step 304 of FIG. 3). For instance, if the block I/O write request spans blocks 1400-1500 for SSD 116, then CPU 104 may analyze how SSD 116 is segmented into regions of blocks, and determine which region(s) blocks 1400-1500 are located within. If, for instance, SSD 116 is segmented into a plurality of 4 MB regions, then each region corresponds to about 1000 blocks (if each block is 4 KB). In this case, a block I/O write request for blocks 1400-1500 would be located in one of the first few regions (e.g., region 1 or 2) of SSD 116, if SSD 116 is segmented in a linear fashion from the lowest block numbers to the highest block numbers. This is merely one example however, and one skilled in the art will recognize that the particular manner or size of the regions, the block size, and the region ordering is a matter of design choice.

In response to identifying a region of SSD 116 that corresponds to the block I/O write request, CPU 104 determines if the region is cached in DRAM 114 (see step 306 of FIG. 3). If the region that corresponds to the block I/O write request is cached in DRAM 114, then CPU 104 directs controller 118 of HBA 112 to perform a memory copy of a block of data for the block I/O write request from host RAM 106 to DRAM 114 (see step 308 of FIG. 3). Generally, the block of data for the block I/O write request corresponds to data block(s) that have been modified and will be written to SSD 116. For instance, if the block I/O write request modifies blocks 1400-1500 of SSD 116, then controller 118 copies the new data from host RAM 106 to DRAM 114. In some embodiments, controller 118 may perform a memory copy from host RAM 106 to DRAM 114 and/or may initiate a DMA transfer from host RAM 106 to DRAM 114 in order to perform this activity. In other embodiments, CPU 104 may perform a memory copy from host RAM 106 to DRAM 114 and/or may initiate a DMA transfer from host RAM 106 to DRAM 114 in order to perform this activity. In response to copying the new blocks of data for the block I/O write request from host RAM 106 to DRAM 114, CPU 104 is able to respond to the requestor that the write request has been completed.

One advantage of responding to the block I/O write request by writing data to DRAM 114 rather than SSD 116 is reduced latency. Typically it is much faster to perform a memory copy or DMA transfer from host RAM 106 to DRAM 114 than it is to wait for SSD 116 to finish a write operation for the new data. Although SSDs in general have lower latencies than rotational media such as Hard Disk Drives, writing to SSDs is still considerably slower than writing to DRAM. Thus, it is desirable to cache write requests for SSD 116 in DRAM 114, if possible. However, differences in the size between DRAM 114 and SSD 116 typically preclude the possibility of caching SSD 116 entirely in DRAM 114.

If the region that corresponds to the block I/O write request is not cached in DRAM 114, then CPU 104 directs controller 118 to cache the region of SSD 116 in DRAM 114 (see step 310 of FIG. 3). For instance, controller 118 may locate the region corresponding to the block I/O write request stored on SSD 116, and then copy the data corresponding to the region from SSD 116 to DRAM 114. In response to caching the region from SSD 116 to DRAM 114, CPU 104 directs controller 118 to copy data for the block I/O write request from host RAM 106 to DRAM 114 (see step 308 of FIG. 3, which has been previously discussed above). In response to writing the new block(s) of data to DRAM 114, CPU 104 may mark the cached region in DRAM 114 as dirty. This indicates that the region will eventually be flushed back to SSD 116 to ensure that SSD 116 stores the most up-to-date data for the cached data. In some cases, CPU 104 may flush dirty regions from DRAM 114 back to SSD 116 that have been used less recently than other regions. This may ensure that the regions of SSD 116 that are more actively written to are available in DRAM 114. This reduces the possibility of a cache miss during processing of block I/O write requests for SSD 116, which improves the performance of HBA 112.

As discussed previously, in some cases CPU 104 may execute a service and/or a device I/O layer within OS 110, which is illustrated in FIGS. 4-5. In particular, FIG. 4 illustrates an application that utilizes a file system read/write interface to access files stored by a SSD, while FIG. 5 illustrates an application that utilizes a memory mapped interface to access files stored by a SSD. FIG. 4 will be discussed first.

FIG. 4 is a block diagram of a host system 402 and a HBA 406 that utilizes a file system interface to access a SSD 416 in an exemplary embodiment. In this embodiment, host system 402 includes a host RAM 404, and host system 402 is communicatively coupled to HBA 406. HBA 406 includes a DRAM 414 that caches regions of a SSD 416. Host system 402 includes a block driver, NVRAMDISK 412 which maps HBA DRAM 414 into the address space of host system 402. Host system 402 further includes an application 408 that executes within an operating system. Application 408 in this embodiment generates file system read/write requests for files stored on SSD 116 utilizing a file system layer 410. File system layer 410 executes within a kernel of the operating system. One example of a read request for a file is the Windows® ReadFile( )function, which accepts parameters such as a handle for the file, a pointer to a buffer in RAM that will receive the data read from the file, the number of bytes to read from the file, etc. File system layer 410 converts the read/write requests for a file stored on SSD 416 into block I/O read/write requests for SSD 416. The block I/O read/write requests for SSD 416 are provided to a NVRAMDISK layer 412. In this embodiment, NVRAMDISK layer 412 identifies the region on SSD 416 that corresponds to the block I/O read/write request, and determines if the region is cached in DRAM 414 of HBA 406. If the region is cached and the block I/O request is a read request (e.g., application 408 is reading from a file stored on SSD 416), then NVRAMDISK layer 412 copies the data from DRAM 414 to host RAM 404. For instance, NVRAMDISK layer 412 may copy the block(s) of data requested from a file to a buffer for file system layer 410. This allows file system layer 410 to respond to a read request generated by application 408.

If the region is cached and the block I/O request is a write request (e.g., application 408 is writing to a file stored on SSD 416), then NVRAMDISK layer 412 copies the data from host RAM 404 to DRAM 414. NVRAMDISK layer 412 may then mark the region as dirty and at some point, flush the dirty data stored by DRAM 414 back to SSD 416. This ensures that SSD 416 stores the most up-to-date copy of data written to cached regions in DRAM 414.

If the region is not cached in either case of a file write or file read, then NVRAMDISK layer 412 copies the region from SSD 416 into DRAM 414. NVRAMDISK layer 412 may then operate as discussed above to perform the file read/write operations generated by application 408.

FIG. 5 is a block diagram of a host system 502 and a HBA 506 that utilizes a memory mapped interface to access a SSD 516 in an exemplary embodiment. In this embodiment, host system 502 includes a host RAM 504. Host system 502 is communicatively coupled to HBA 506. HBA 506 includes a DRAM 514 that caches regions of SSD 516. Host system 502 further includes an application 508 that executes within an operating system. Application 508 in this embodiment maps a block device for SSD 516 into an address space of application 508, and the operating system for application 508 will allocate some pages in host RAM 504 that store data from SSD 516. A page table is generated which maps SSD 516 to host RAM 504, with non-cached pages of SSD 516 marked as invalid. When application 508 generates a load/store for data on SSD 516, if the page is cached in host RAM 504, then application 508 can directly access this data without overhead from the operating system. If the page is not present, then a page fault occurs. A memory management subsystem 510 utilizes the page fault information and the load/store information from application 508 and converts this into a block I/O request for a NVRAMDISK layer 512. In the case of a block I/O read request, NVRAMDISK layer 512 copies the requested data from DRAM 514 to host RAM 514 (if the region is cached in DRAM 514), or first caches the region from SSD 516 to DRAM 514 (if the region is not cached in DRAM 514). In the case of a block I/O write request, NVRAMDISK layer 512 copies the new data from host RAM 504 to DRAM 514 (f the region is cached in DRAM 514), or first caches the region from SSD 516 to DRAM 514 (if the region is not cached in DRAM 514). Dirty regions cached in DRAM 514 are eventually flushed back to SSD 516 to ensure that the regions stored on SSD 516 include the most up-to-date data.

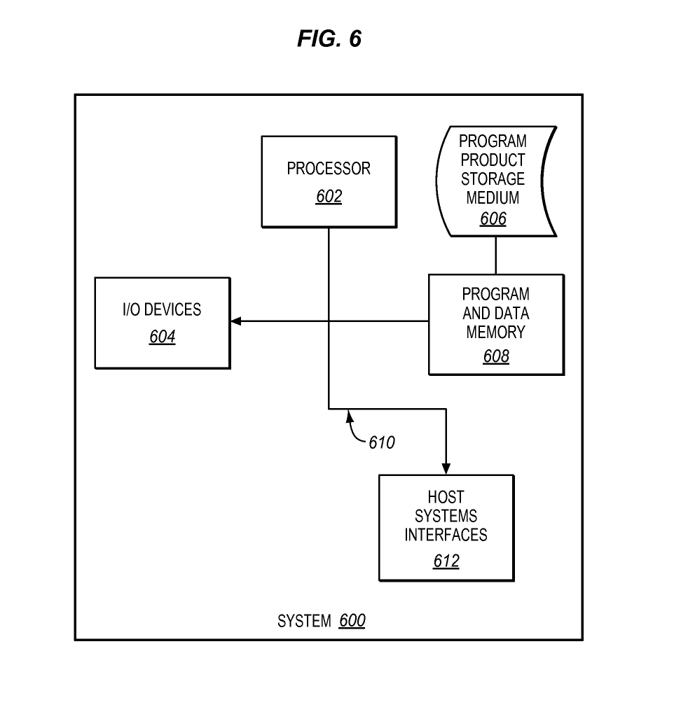

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. FIG. 6 illustrates system 600 in which a computer readable medium 606 may provide instructions for performing the methods disclosed herein.

Furthermore, the invention can take the form of a computer program product accessible from a computer-usable or computer-readable medium 606 providing program code for use by or in connection with a computer or any instruction execution system. For the purposes of this description, a computer-usable or computer readable medium 606 can be any apparatus that can contain, store, communicate, or transport the program for use by or in connection with the instruction execution system, apparatus, or device.

The medium 606 can be an electronic, magnetic, optical, electromagnetic, infrared, or semiconductor system (or apparatus or device). Examples of a computer-readable medium 606 include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 602 coupled directly or indirectly to memory elements 608 through a system bus 610. The memory elements 608 can include local memory employed during actual execution of the program code, bulk storage, and cache memories which provide temporary storage of at least some program code in order to reduce the number of times code is retrieved from bulk storage during execution.

Input/output or I/O devices 604 (including but not limited to keyboards, displays, pointing devices, etc.) can be coupled to the system either directly or through intervening I/O controllers.

Network adapters may also be coupled to the system to enable the data processing system to become coupled to other data processing systems, such as through host systems interfaces 612, or remote printers or storage devices through intervening private or public networks. Modems, cable modem and Ethernet cards are just a few of the currently available types of network adapters.

What is claimed is:

1. An apparatus comprising:
a host system including a host processor and a host memory; and
a Host Bus Adapter (HBA) including a Solid State Disk (SSD) and a Dynamic Random Access Memory (DRAM) that is operable to cache regions of the SSD;
the host processor operable to identify a block Input/Output (I/O) read request for the SSD, to identify a region of the SSD that corresponds to the block I/O read request, and to determine if the region of the SSD is cached in the DRAM of the HBA;
the host processor, responsive to determining that the region of the SSD is cached in the DRAM of the HBA, is further operable to:
direct the HBA to perform a memory copy of a block of data for the block I/O read request from the cached region of the SSD to the host memory; and
respond to the block I/O read request for the SSD utilizing the block of data in the host memory;
the host processor, responsive to determining that the region of the SSD is not cached by the DRAM of the HBA, is further operable to:
direct the HBA to cache the region of the SSD in the DRAM of the HBA;
direct the HBA to perform a memory copy of the block of data for the block I/O read request from the cached region of the SSD to the host memory; and
respond to the block I/O read request for the SSD utilizing the block of data in the host memory.

2. The apparatus of claim 1 wherein:
the host processor is further operable to determine if the DRAM of the HBA has space available for a caching a new region of the SSD, and responsive to determining that the space is not available, the processor is further operable to:
direct the HBA to transfer a cached region of the SSD from the DRAM of the HBA to the SSD if the cached region includes dirty data; and
mark the cached region of the SSD in the DRAM of the HBA as available for caching the new region of the SSD if the cached region does not include dirty data.

3. The apparatus of claim 2 wherein:
the host processor is further operable to select a least recently used cached region of the SSD for transfer from the DRAM of the HBA to the SSD.

4. The apparatus of claim 1 wherein:
the host processor operable to identify a block I/O write request for the SSD, to identify a region of the SSD that corresponds to the block I/O write request, and to determine if the region of the SSD is cached in the DRAM of the HBA;
the host processor, responsive to determining that the region of the SSD is cached in the DRAM of the HBA, is further operable to direct the HBA to perform memory copy of a block of data for the block I/O write request from the host memory to the cached region of the SSD; and
the host processor, responsive to determining that the region of the SSD is not cached in the DRAM of the HBA, is further operable to:
direct the HBA to cache the region of the SSD in the DRAM of the HBA; and
direct the HBA to perform a memory copy of the block of data for the block I/O write request from the host memory to the cached region of the SSD.

5. The apparatus of claim 4 wherein:
the host processor is further operable to mark the cached region of the SSD as dirty.

6. The apparatus of claim 5 wherein:
the host processor is further operable to direct the HBA to copy cached regions of the SSD marked as dirty from the DRAM of the HBA to the SSD.

7. The apparatus of claim 1 wherein:
the host processor is further operable to register the SSD as a block I/O device for an Operating System (OS) of the host system; and
the block I/O read request includes a begin block number of the SSD and a number of blocks to read from the SSD.

8. A method comprising:
identifying, by a host processor of a host system, a block Input/Output (I/O) read request for a Solid State Disk (SSD) of Host Bus Adapter (HBA);
identifying, by the host processor, a region of the SSD that corresponds to the block I/O read request;
determining, by the host processor, if the region of the SSD is cached in a Dynamic Random Access Memory (DRAM) of the HBA;
responsive to determining that the region of the SSD is cached in the DRAM of the HBA, performing the steps of:
directing, by the host processor, the HBA to perform a memory copy of a block of data for the block I/O read request from the cached region of the SSD to a host memory of the host system; and
responding, by the host processor, to the block I/O read request for the SSD utilizing the block of data in the host memory;
responsive to determining that the region of the SSD is not cached by the DRAM of the HBA, performing the steps of:
directing, by the host processor, the HBA to cache the region of the SSD in the DRAM of the HBA;
directing, by the host processor, the HBA to perform a memory copy of the block of data for the block I/O read request from the cached region of the SSD to the host memory; and
responding, by the host processor, to the block I/O read request for the SSD utilizing the block of data in the host memory.

9. The method of claim 8 further comprising:
determining, by the host processor, if the DRAM of the HBA has space available for a caching a new region of the SSD; and
responsive to determining that the space is not available, performing the steps of:
directing, by the host processor, the HBA to transfer a cached region of the SSD from the DRAM of the HBA to the SSD if the cached region includes dirty data; and
marking, by the host processor, the cached region of the SSD in the DRAM of the HBA as available for caching the new region of the SSD if the cached region does not include dirty data.

10. The method of claim 9 further comprising:
selecting, by the host processor, a least recently used cached region of the SSD for transfer from the DRAM of the HBA to the SSD.

11. The method of claim 8 further comprising:
identifying, by the host processor, a block I/O write request for the SSD;
identifying, by the host processor, a region of the SSD that corresponds to the block I/O write request;
determining, by the host processor, if the region of the SSD is cached in the DRAM of the HBA;
responsive to determining that the region of the SSD is cached in the DRAM of the HBA, performing the step of:
directing, by the host processor, the HBA to perform a memory copy of a block of data for the block I/O write request from the host memory to the cached region of the SSD; and
responsive to determining that the region of the SSD is not cached in the DRAM of the HBA, performing the steps of:
directing, by the host processor, the HBA to cache the region of the SSD in the DRAM of the HBA; and
directing, by the host processor, the HBA to perform a memory copy the block of data for the block I/O write request from the host memory to the cached region of the SSD.

12. The method of claim 11 further comprising:
marking, by the host processor, the cached region of the SSD as dirty.

13. The method of claim 12 further comprising:
directing, by the host processor, the HBA to copy cached regions of the SSD marked as dirty from the DRAM of the HBA to the SSD.

14. The method of claim 8 further comprising:
registering, by the host processor, the SSD as a block I/O device for an Operating System (OS) of the host system,
wherein the block I/O read request includes a begin block number of the SSD and a number of blocks to read from the SSD.

15. A non-transitory computer readable medium embodying programmed instructions which, when executed by a host processor of a host system, direct the host processor to:
identify a block Input/Output (I/O) read request for a Solid State Disk (SSD) of Host Bus Adapter (HBA);
identify a region of the SSD that corresponds to the block I/O read request;
determine if the region of the SSD is cached in a Dynamic Random Access Memory (DRAM) of the HBA;
responsive to a determination that the region of the SSD is cached in the DRAM of the HBA, the instructions further direct the host processor to:
direct the HBA to perform a memory copy a block of data for the block I/O read request from the cached region of the SSD to a host memory of the host system; and
respond to the block I/O read request for the SSD utilizing the block of data in the host memory;
responsive to a determination that the region of the SSD is not cached by the DRAM of the HBA, the instructions further direct the processor to:
direct the HBA to cache the region of the SSD in the DRAM of the HBA;
direct the HBA to perform a memory copy the block of data for the block I/O read request from the cached region of the SSD to the host memory; and
respond to the block I/O read request for the SSD utilizing the block of data in the host memory.

16. The non-transitory computer readable medium of claim 15, wherein the instructions further direct the host processor to:
determine if the DRAM of the HBA has space available for a caching a new region of the SSD; and
responsive to a determination that the space is not available, the instructions further direct the host processor to:
direct the HBA to transfer a cached region of the SSD from the DRAM of the HBA to the SSD if the cached region includes dirty data; and
mark the cached region of the SSD in the DRAM of the HBA as available for caching the new region of the SSD if the cached region does not include dirty data.

17. The non-transitory computer readable medium of claim 16, wherein the instructions further direct the host processor to:
select a least recently used cached region of the SSD for transfer from the DRAM of the HBA to the SSD.

18. The non-transitory computer readable medium of claim 15, wherein the instructions further direct the host processor to:
identify a block I/O write request for the SSD;
identify a region of the SSD that corresponds to the block I/O write request;
determine if the region of the SSD is cached in the DRAM of the HBA;
responsive to a determination that the region of the SSD is cached in the DRAM of the HBA, the instructions further direct the processor to:
direct the HBA to perform a memory copy of a block of data for the block I/O write request from the host memory to the cached region of the SSD; and
responsive to a determination that the region of the SSD is not cached in the DRAM of the HBA, the instructions further direct the processor to:
direct the HBA to cache the region of the SSD in the DRAM of the HBA; and
direct the HBA to perform a memory copy of the block of data for the block I/O write request from the host memory to the cached region of the SSD.

19. The non-transitory computer readable medium of claim 18, wherein the instructions further direct the host processor to:
mark the cached region of the SSD as dirty.

20. The non-transitory computer readable medium of claim 19, wherein the instructions further direct the host processor to:
direct the HBA to copy cached regions of the SSD marked as dirty from the DRAM of the HBA to the SSD.
